(19) United States
(12) Patent Application Publication
(10) Pub. No.: US 2007/0125489 A1
(43) Pub. Date: Jun. 7, 2007

(54) Microfluidic welded devices or components thereof and method for their manufacture

(75) Inventors: Brian Kevin Paul, Corvallis, OR (US); Goran Jovanovic, Corvallis, OR (US)

Correspondence Address: KLARQUIST SPARKMAN, LLP, 121 SW SALMON STREET, SUITE 1600, PORTLAND, OR, 97204, US

(73) Assignee: Oregon State University

(21) Appl. No.: 11/517,731

(22) Filed: Sep. 8, 2006

Related U.S. Application Data
(60) Provisional application No. 60/715,466, filed on Sep. 8, 2005.

(51) Int. Cl. B32B 37/00

(52) U.S. Cl. 156/272.8; 156/308.2

(57) ABSTRACT

One embodiment of the disclosed welding process comprises providing plural heterogeneous materials, such as plural polymeric laminae, that form at least a part of a microfluidic device. Electromagnetic energy, such as laser or microwave energy, is applied to the materials for a period of time sufficient to effectively bond the heterogeneous materials together. For certain embodiments such method comprises providing plural laminae made from a first material, such as a substantially rigid material, positioned to substantially encompass at least one additional lamina made from a second, less rigid material.

### CROSS REFERENCE TO RELATED APPLICATION

This application claims the benefit of the earlier filing date of U.S. patent application No. 60/715,466, entitled Microwave Welding, which was filed on Sep. 8, 2005, and is incorporated herein by reference.

### FIELD

The present application concerns embodiments of a welding process for making microfluidic devices, typically microfluidic devices comprising plural heterogeneous materials, and devices made by the method.

### BACKGROUND

A. Microfluidic Devices

For the emerging micro-and nanotechnology fields, useful devices can be made much smaller than previously was possible. Such devices often include embedded features, such as microchannels, that can be made using lamina architecture. Certain embodiments of these methods are described in the U.S. patent literature. For example, U.S. Pat. Nos. 6,672,502 and 6,793,831, which are incorporated herein by reference, describe methods for making devices comprising providing plural laminae that are stacked, registered, and bonded to form monolithic devices.

Many useful microfluidic devices, such as filtration-type devices, require membranes that are operatively associated with the embedded features. Examples of Microtechnology-based Energy and Chemical Systems (MECS) devices that require integrating various types of membranes within a microlaminated stack include: fluid separation devices, such as are useful for hydrogen or oxygen separation; catalysis-based devices, such as devices for performing reforming reactions within microchannel fuel processing systems; microchannel absorbers for use in heat pumps; fluid oxygenators, such as oxygenators used in the heart-lung machine; and microchannel dialyzers for portable kidney dialysis, such as described in U.S. application No. 60/616,877, entitled Microfluidic Devices, Particularly Filtration Devices Comprising Polymeric Membranes, and Method for Their Manufacture and Use, which is incorporated herein by reference.

There are other types of devices having elastomeric materials that perform functions other than fluid purification or separation. For example, such materials can be used as valve materials that are operatively associated with adjacent microchannels. When actuated, such materials deflect into the microchannel to control flow into, out of or through microchannels. Examples of such devices include biodiesel reactors, or highly-branched networks of microreactors for molecular manufacturing (e.g. dendrimer synthesis; see, for example, U.S. patent application Ser. No. 11/086,074, entitled Microchemical Nanofactories, incorporated herein by reference, which discloses systems comprising fluidly actuatable valves in a microchannel-based system, and illustrates production of such nanofactories using plural lamina, at least some of which have elastomeric valves associated therewith).

One difficulty associated with making such devices is the method selected to bond plural heterogeneous layers together to form the desired device. This problem is exacerbated where at least one of the layers comprises a membrane. These membranes typically are made from materials that are substantially less rigid or have a substantially lower tensile strength or flexural modulus than the other materials adjacent the membrane.

A potentially useful technique for bonding together plural laminae is ultrasonic welding, which is disclosed in U.S. patent application Ser. No. 11/086,074, incorporated herein by reference. One major issue involved with ultrasonic welding is that multi-layer structures are difficult to weld because a reasonable amount of stiffness is required to transmit ultrasonic energy between many different laminae. FIGS. 16 and 18 of the '074 application illustrate ultrasonic welds. FIG. 18 clearly demonstrates that ultrasonic welding can be used to produce quality welds in a heterogeneous stack of materials, such as the illustrated polydimethylsiloxane (PDMS) membrane associated with microchannels defined by polycarbonate laminae positioned adjacent the PDMS membrane. However FIG. 16 also illustrates another problem associated with welding together a heterogeneous stack; deflection of the elastomeric PDMS layer into the microchannel. If too much deflection occurs, the elastomeric material blocks the microchannel, thereby precluding proper device function. Furthermore, ultrasonic welding involves vibrational energy. This vibration energy makes it difficult to keep membranes flat during bonding. This vibrational energy also can damage the membrane, or create other problems, such as misalignment of the membrane and associated features on adjacent laminae.

With reference to other bonding techniques, thermal bonding requires significant time periods to achieve adequate bonds. Also, maintaining a uniform bonding temperature is difficult in large stacks involving 50-100 laminae. Another potential welding method, solvent welding, is both difficult to automate and also may leave residues in the bond area that can leach into microfluidic channels.

B. Microwave Welding

Microwave welding is a nascent technology and only limited information is available concerning the technology. The information that is available generally concerns investigating operating parameters potentially useful for constructing simplistic devices or components of such devices. For example, a publication by Yussuf et al entitled “Microwave Welding of Polymeric-Microfluidic Devices,” states that:
This paper describes a novel technique for bonding polymeric-microfluidic devices using microwave energy and a conductive polymer (polyaniline). The bonding is achieved by patterning the polyaniline features at the polymer joint interface by filling of milled microchannels. The absorbed electromagnetic energy is then converted into heat, facilitating the localized microwave bonding of two polymethylmethacrylate (PMMA) substrates. A coaxial open-ended probe was used to study the dielectric properties at 2.45 GHz of the PMMA and polyaniline at a range of temperatures up to 120° C. The measurements confirm a difference in the dielectric loss factor of the PMMA substrate and the polyaniline, which means that differential heating using microwaves is possible. Microfluidic channels of 200 μm and 400 μm widths were sealed using a microwave power of 300 W for 15 s. The results of the interface evaluations and leak test show that strong bonding is formed at the polymer interface, and there is no fluid leak up to a pressure of 1.18 MPa. Temperature field of microwave heating was found by using direct measurement techniques. A numerical simulation was also conducted by using the finite-element method, which confirmed and validated the experimental results. These results also indicate that no global deformation of the PMMA substrate occurred during the bonding process.
   Micromech. Microeng. 15 1692-1699 (2005). This publication is not a statutory bar for the subject matter disclosed by such reference relative to that disclosed in the present application, and applicants make no admission as to the prior art effects of the subject matter disclosed by the reference by including such information in the present application. Moreover, as currently understood, Yussuf discloses an architecture that has just enough layers to define a microchannel, and provides no information concerning more difficult architectures having microchannels in plural different “stacked” layers. Yussuf also provides no disclosure concerning microwave welding an architecture comprising laminae that define microchannels and an encompassed membrane adjacent to such microchannels.

Microwave welding devices also are known commercially. For example, The Welding Institute (TWI) states that:
The possibility of using microwaves to weld thermoplastics has existed since the development of the magnetron in the 1940s. In 1993, TWI built a research facility to explore the feasibility of exploiting such an operation. The modified multimode cavity, similar in nature to a microwave oven, operates at a frequency of 2.45 GHz and has the capability to apply pressure to a joint.
Most thermoplastics do not experience a temperature rise when irradiated by microwaves. However, the insertion of a microwave susceptible implant at the joint line allows local heating to take place. If the joint is subjected simultaneously to microwaves and an applied pressure, melting of the surrounding plastic results and a weld is formed. Suitable implants include metals, carbon or one of a range of conducting polymers, but whichever is selected becomes a consumable in the welding process. The particular advantage of microwave welding over other forms of welding is its capability to irradiate the entire component and consequently produce complex three-dimensional joints. Welds are typically created in less than one minute.
The technique is still in the development stages and as such there are currently no reported industrial applications. However, it is anticipated that microwave welding may prove to be suitable for joining automotive under-body components and domestic appliance parts.
   TWI's website (http://www.twi.co.uk, accessed on Sep. 2, 2005), emphasis added.

### SUMMARY

Based on the above, a need exists for welding techniques useful for making devices having substantially more complicated architectures than have been considered previously. Moreover, an electromagnetic energy welding technique useful for welding an architecture comprising plural laminae, at least one of which is a lamina having substantially different properties than adjacent lamina, such as elastomeric valve or membrane lamina, bounded by other “packaging” laminae, is required. The presently disclosed technology satisfies that need.

One embodiment of the disclosed welding process comprises providing plural heterogeneous materials that form at least a part of a microfluidic device. Electromagnetic energy is applied to the materials for a period of time sufficient to effectively bond the heterogeneous materials together. For certain embodiments such method comprises providing plural laminae made from a first material, such as a substantially rigid material, examples of which include polycarbonate, and ceramic materials such as alumina, zirconia and titania. The plural laminae of the first material are positioned to substantially encompass at least one additional lamina made from a second material, such as a less rigid material, examples of which include polydimethylsiloxane, polysulfone, nanocrystalline cellulose, and combinations thereof.

Where the first material is substantially rigid, and the second material is less rigid, such second material may include apertures for receiving portions defined by the first material therein. These portions act to register the second material and to maintain the second material in at least slight tension.

The disclosed process is useful for processing two or only a few laminae. More important, however, the process also is useful for processing relatively large numbers of laminae, such as at least 50 laminae, and potentially several hundreds of laminae.

Embodiments of the method may further comprise placing electromagnetic energy susceptible material on at least a portion of a faying surface of one or more of the plural lamina to selectively absorb applied energy. The electromagnetic energy susceptible material may be any suitable material for the purpose including, but not limited to, carbon, a metal, a metal alloy, such as iron or an alloy comprising iron, a conductive polymer, such as poly(para-phenylene), poly(p-phenylenevinylene), polyaniline, and combinations thereof. The electromagnetic energy susceptible material may be provided in desired forms, such as powders, films, pastes, epoxies, or combinations thereof. The electromagnetic energy susceptible material also may be dispersed in a material curable by heat production as a result of electromagnetic energy absorption by the electromagnetic energy susceptible material. Alternatively, individual lamina or laminae may be produced to include an electromagnetic energy susceptible material.

The electromagnetic energy susceptible material may be placed on at least a portion of the faying surface of the laminae by any suitable method. Examples of such methods include manually applying the material, dip coating, inkjet-based systems, xerographic processes that deposit particles using electrostatic forces, screen printing, stencil printing, lithography-based methods, and combinations thereof. One lamina of the first material also may include standoffs. In this situation, the method may further comprise positioning electromagnetic energy susceptible material on a faying surface of the standoffs to direct energy absorption.

The process may further comprise determining the electromagnetic energy absorption frequency range of the electromagnetic energy susceptible material. The applied electromagnetic energy frequency is then selected to be within the electromagnetic energy absorption frequency range of the electromagnetic energy susceptible material.

Other methods can be used to increase the heat effects associated with energy absorption, or to further localize the effects. For example, porous substrate materials may be used to selectively enhance temperature. As a second example, a faying surface may comprise a sub-wavelength structured surface having different dielectric constants to selectively enhance temperature during microwave bonding.

The laminae may be non-patterned, or one, more than one, or all of the laminae may be patterned. Patterned laminae may be patterned simultaneously with the application of electromagnetic energy susceptible material to faying surface(s) of the laminae.

The process may further comprise subjecting the plural laminae to a first and second energy source. The second energy source may be any useful energy source that facilitates the bonding process, such as IR or heat energy. And, the process may-further comprise subjecting the plural laminae to at least a second bonding process selected from diffusion soldering/bonding, thermal brazing, adhesive bonding, thermal adhesive bonding, curative adhesive bonding, electrostatic bonding, resistance welding, microprojection welding, ultrasonic welding, and combinations thereof.

The method also typically comprises applying a bonding pressure to the plural laminae. The bonding pressure generally is applied simultaneously while applying electromagnetic energy, or substantially immediately thereafter. The bonding pressure is selected to provide a weld joint strength and/or conformal seal sufficient to withstand fluid pressures experienced during device operation. These fluid pressures may vary, but typically are within a range of from greater than 0 atmosphere to less than about 10 atmospheres.

The foregoing and other objects, features, and advantages of the invention will become more apparent from the following detailed description, which proceeds with reference to the accompanying figure.

### BRIEF DESCRIPTION OF THE DRAWING

FIG. 1 is a schematic cross sectional diagram of a microfluidic device comprising plural laminae positioned to define microchannels adjacent a lamina made from an elastomeric material.

FIG. 2 is a schematic drawing illustrating one laser welding embodiment illustrating welding a polycarbonate/SM122/polycarbonate stack

FIG. 3 is a schematic diagram illustrating one embodiment of a device used for motion control during a laser welding process.

FIG. 4 is a schematic diagram illustrating certain laser welding control parameters.

FIG. 5 is a graph illustrating failure analysis results of weld pressure tests for various polymeric materials.

FIG. 6 is a schematic perspective view illustrating an assembly comprising a bottom lamina and having a membrane thereon indicating laser tack welding positions according to one embodiment of the present invention.

FIG. 7 is a plan view of an assembly comprising a bottom lamina, a top lamina, and a membrane therebetween, with inset FIG. 7A, showing the assembly in cross section.

FIG. 8 is a perspective schematic view of three laminae used to form dialyzer-based test coupons.

FIG. 9 is a flow chart for one embodiment of a process useful for forming test coupons of FIG. 8 having an AN69 membrane.

FIG. 10 is a flow chart for one embodiment of a process useful for forming test coupons of FIG. 8 having a cellulose acetate membrane.

FIG. 11 is a digital photomicrograph illustrating a welded assembly.

FIG. 12 is a digital photomicrograph illustrating a welded assembly.

### DETAILED DESCRIPTION

### I. GENERAL DISCUSSION

Disclosed embodiments of the present invention are particularly directed to a method for making devices, particularly microfluidic devices that comprise plural components of different composition and physical properties. One example of such a device is a microfluidic device comprising at least one layer that acts as a membrane, such as a separation membrane, or that acts as a fluidly actuatable valve, such as described in copending U.S. patent application, entitled Microchemical Nanofactories, filed on Sep. 1, 2006.

Particular embodiments concern a welding process involving applying electromagnetic radiation to a work piece using conditions effective to form a weld between adjacently positioned components of a microfluidic device. Electromagnetic energy that could be used in these welding processes includes infrared (700 nm to 1 mm), microwave (1 mm to 1 m) and radio waves (above 1 m). In particular, the near infrared region between about 750 nm to 1.45 micrometers and the mid-infrared region around 10 micrometers seems to be commercially viable in the form of solid state (Nd:YAG, Yb:YAG), diode and gas (CO2) lasers. Other commercial infrared sources include infrared emitters based on heating elements, which can be coupled with converyors for continuous IR ovens capable of welding devices. Commercial microwave sources, or magnetrons, are generally available for generating microwaves around 2.45 GHz (12.24 cm). Some larger industrial sources generate microwaves around 915 MHz. Multi-mode sources tend to be larger with lower power coupling to the weldment than single mode sources. For lamination of a large number of laminae (two or more), directional energies such as lasers can prevent parallel processing of the stack. In certain instances with a small number (3-20) of laminae, sequential processing of large laminae with a curtain laser may be economically viable. However, laminae stacks will be easier to process by a non-coherent source as the number of laminae increasees, making these devices more economical to produce.

Different mechanisms exist for welding. In radio frequency (RF) welding, electromagnetic fields cause dipole vibrations that generate heat within an implant material on the bond line of the welds, or included in the composition of the material being welded. In laser transmission welding, through transmission infrared welding and microwave welding, the energy is absorbed into an implant material on the bond line and converted into heat at the bond line. Patterning of electromagnetic susceptible materials onto electromagnetically transparent materials allows controlling electromagnetic energy deposition for producing complex three-dimensional welds. Examples of patterned implant material includes various forms of deposition of implant particle suspensions as well as using composite gaskets containing a particulate implant material or materials.

Different materials will work better for different welding processes. Polycarbonate is known to have higher absorptivity in the IR range than ABS or PMMA. Polypropylene, fluoropolymers and PMMA are known to have low absorptivity in the microwave range. The dielectric loss (loss factor) is a measure of how well a material absorbs the electromagnetic energy to which it is exposed. The dielectric constant is a measure of the polarizability of a material, essentially how strongly it resists the movement of either polar molecules or ionic species in the material. Materials with low dielectric loss and high dielectric constant at the welding wavelength make for good packaging and membrane materials. Materials with high dielectric loss and low dielectric constant make for good implant materials.

Likely commercial wavelengths to be used include (delivery through a fiber optic or an optic train of mirrors) Nd:YAG (1.064 micron), CO₂ (10.6 micron), fiber lasers (e.g. 1.03 micron Yb:YAG), and semiconductor diode lasers (0.8 to 1.0 micron).

Microwave welding and laser welding techniques are discussed in particular detail to exemplify applying electromagnetic energy to a work piece to form a weld.

### II. MICROLAMINATION

A. Generally

Devices disclosed herein may be produced by a fabrication approach known as microlamination. Microlamination methods are described in several patents and pending applications commonly assigned to Oregon State University, including U.S. Pat. Nos. 6,672,502 and 6,793,831, and several patent applications, including international application No. polycarbonateT/US2004/035,452, entitled High Volume Microlamination Production of Devices, U.S. application Ser. No. 11/086,074, entitled Microchemical Nanofactories, and U.S. provisional application No. 60/616,877, entitled Microfluidic Devices, Particularly Filtration Devices Comprising Polymeric Membranes, and Method for Their Manufacture and Use, all of which are incorporated herein by reference.

Briefly, microlamination consists of patterning and bonding thin layers of material, referred to herein as lamina or laminae, together to form an assembled device having embedded features. Microlamination typically involves at least three levels of production technology: (1) lamina patterning, (2) laminae registration, and (3) laminae bonding. The method also may include dissociating components (i.e., substructures from structures) to make the device. Component dissociation can be performed prior to, subsequent to, or simultaneously with bonding the laminae.

In one aspect of the present invention, laminae are formed from a variety of materials that are substantially transparent to microwaves, particularly polymeric materials, including solely by way of example and without limitation, PDMS, polysulfones, polyimides, polyalkylacrylates, such as polymethylmethacrylate, etc.; ceramics, such; and combinations of such materials. The proper selection of a material for a particular application is best determined by considering a number of factors, including material properties, such as the physical properties of the material, e.g., tensile strength, modulus, the temperature and/or pressure under which the material operates effectively, cost, availability, etc.

Laminae useful for microlamination can have a variety of sizes. Generally, the laminae have thicknesses of from about 1 mil to about 32 mils, preferably from about 2 mils to about 10 mils, and even more preferably from about 3 to about 4 mils (1 mil is 1 one-thousandth of an inch). Individual lamina within a stack also can have different thicknesses.

B. Forming Laminae

Lamina forming may comprise machining or etching a pattern in the lamina. The pattern formed depends on the device being made. Without limitation, techniques for machining or etching include embossing, such as micro hot embossing, which may be used to pattern, for example, polycarbonate and polysulfone, casting, such as spin casting, roll forming, stamping, cutting techniques, such as laser-beam, electron-beam, ion-beam, electrochemical, and electrodischarge type techniques, chemical and mechanical material deposition or removal, etc. Lamina also can be formed both by lithographic and non-lithographic processes. Lithographic processes include micromolding and electroplating methods, such as LIGA, and other net-shape fabrication techniques. Some additional examples of lithographic techniques include chemical micromachining (i.e., wet etching), photochemical machining, through-mask electrochemical micromachining (EMM), plasma etching, as well as deposition techniques, such as chemical vaporization deposition, sputtering, evaporation, and electroplating. Non-lithographic techniques include electrodischarge machining (EDM), mechanical micromachining and laser micromachining (i.e., laser photoablation). Photochemical and electrochemical micromachining may be preferred for mass-producing devices.

Elastomer valve lamina may be formed by spin casting a suitable material, such as a PDMS monomer, onto a wafer. The wafer may include raised photoresist features that form valve chambers. The spin cast material is then cured, and if necessary, machined, such as by laser machining features such as openings. Membrane materials also are commercially available.

C. Laminae Registration

Laminae registration comprises (1) stacking the laminae so that each of the plural lamina in a stack used to make a device is in its proper location within the stack, and (2) placing adjacent laminae with respect to each other so that they are properly aligned as determined by the design of the device. It should be recognized that a variety of methods can be used to properly align laminae, including manually and visually aligning laminae.

The precision to which laminae can be positioned with respect to one another may determine whether an assembled device functions properly. The complexity may range from structures such as microchannel arrays, which are tolerant to a certain degree of misalignment, to more sophisticated devices requiring highly precise alignment. For example, a small scale device may need a rotating sub-component requiring miniature journal bearings axially positioned to within a few microns of each other. Several alignment methods can be used to achieve the desired precision. Registration can be accomplished, for example, using an alignment jig that accepts the stack of laminae and aligns each using some embedded feature, e.g., corners and edges, which work best if such features are common to all laminae. Another approach incorporates alignment features, such as holes, into each lamina at the same time other features are being machined. Alignment jigs are then used that incorporate pins that pass through the alignment holes. The edge alignment approach can register laminae to within 10 microns, assuming the laminae edges are accurate to this precision. With alignment pins and a highly accurate lamina machining technique, micron-level positioning is feasible. Pick-and-place robotics with visual feedback also can be used to register laminae.

### III. LAMINAE BONDING GENERALLY

Laminae bonding comprises bonding the plural laminae one to another to form an assembled device (also referred to as a laminate). Laminae bonding can be accomplished by a number of methods including, without limitation, diffusion soldering/bonding, thermal brazing, adhesive bonding, thermal adhesive bonding, curative adhesive bonding, electrostatic bonding, resistance welding, microprojection welding, ultrasonic welding, and combinations thereof.

However, the present application is particularly directed to welding by applying electromagnetic energy, particularly microwave and laser energy. This technique further enables embodiments of a method for making microscale fluid purification, separation, and synthesis devices. Such devices may comprise a fluid membrane that separates two or more fluids flowing through plural microchannels operatively associated with the membrane. The fluids can both be liquids, gases, or a liquid and a gas, such as may be used for gas absorption into a liquid. Often, the membrane is a semipermeable membrane, such as might be used with a filtration device, such as a dialyzer. Other embodiments of disclosed devices may include other heterogeneous assemblies that are suitable for welding using disclosed embodiments of the present invention.

A. Bonding Heterogeneous Stacks of Polymers

Filtration units, such as a portable kidney dialysis unit, are “bulk microfluidic devices” because of the relatively larger volumes of fluid that are processed in microchannels relative to traditional “lab-on-a-chip” technology. Microchannel cross-sections can be produced to handle these fluid flows using highly-parallel arrays of microchannels. For such bulk microfluidic devices, it is desirable to (1) produce highly-paralleled arrays (for example, devices having 50 or more microchannels), and (2) integrate membranes. For a 50 microchannel device, at least 50 laminae needed to be welded together to form a working device. It is much more economical to produce these devices using one welding cycle for the whole stack, or at least a portion of the entire stack, rather than welding laminae together layer-by-layer.

B. Membrane Integration

MECS devices may integrate various types of membranes within a microlaminated stack. Examples include, without limitation: integrating Pd membranes for hydrogen separation within microchannel fuel processing systems; integrating contactor membranes in microchannel absorbers for use in heat pumps; integrating separation membranes into microchannel dialyzers for portable kidney dialysis; integrating elastomeric membranes into highly-branched networks of microreactors for molecular manufacturing (e.g. dendrimer synthesis); liquid-gas contactor useful for absorption of a gas, such as oxygen into a liquid, such as blood; separating CO₂ and/or H₂S from natural gas; water purification such as by separating organic materials, such as organic acids from water. In each of these examples, heterogeneous materials must be integrated into a laminated stack.

A number of factors typically are considered to integrate membrane within embedded microchannel systems. For example, membrane materials generally are quite expensive, and therefore it is desirable to minimize the amount of membrane material used. This can be accomplished using a second, less expensive packaging material that needs to be integrated with the membrane material.

Also, membrane materials may have specific nano- or micro-morphologies which dictate the mass transfer of the membrane. These morphologies often are sensitive to heat, pressure and other processing conditions. Therefore, these materials cannot be conveniently patterned into geometries compatible with microchannel designs. A mechanism therefore is needed to incorporate the raw material form within the microlaminated stack.

Many techniques used to bond together elements made from a single material are less suitable for bonding together elements made from different materials. An example might be ultrasonic welding or thermal bonding of two polymers with significantly different glass transition temperatures where the structural form of one is compromised at a temperature lower than would be used for welding the second polymer. Also, solvent welding is complicated because different solvents are needed for different materials. Finally, plasma oxidation produces excellent welds between polydimethylsiloxane, polyethylene or polystyrene, but cannot be used effectively for other combinations of materials.

Membranes often have a thickness, or are made out of a material, that results in poor stiffness. Consequently, one non-trivial factor is producing a microchannel array with interspersed membranes that do not result in significant fin warpage and channel non-uniformities. Channel non-uniformities can lead to flow maldistribution, which negatively impacts the effectiveness of heat exchangers and microreactors.

The low modulus of some membranes requires that the layers be thick (on the order of one mm) in order to maintain dimensions. Therefore, in order to reduce the fluid volume of the MECS device being developed while meeting its processing and operating requirements, it is desirable to integrate the elastomeric capabilities of certain materials, such as PDMS, with a stiff material.

While some membranes are excellent candidates as valve membranes or other purposes, they are not good for packaging. One issue with separation membranes is that they are highly gas permeable, which can cause evaporation in microchannels leading to vapor-lock.

Another issue is that most membranes are not suitable as substrates for thin film deposition of heaters and thermocouples. Therefore, where such devices are required, new methods must be developed for their incorporation into working devices.

### IV. MICROWAVE WELDING USING MICROWAVE TRANSPARENT MATERIALS

The present application is particularly useful for, but is not limited to, a method for making microfluidic devices that process relatively large volumes of fluids. Microfluidic devices have an ever increasing complexity and capacity to process fluids; nevertheless, these devices still must be made as small as possible. This can be accomplished by, for example, increasing the cross sectional thickness of a device and arraying microfluidic channels and associated architectures throughout the cross section of the device. These devices can include several hundreds of layers, and bonding must occur throughout the entire cross section using methods that do not result in microchannel obstruction. This is substantially more difficult to achieve than with a single or only a few layers. Bonding of such architectures is further complicated when the device requires integrating one or more membranes that are made from a material other than the material or materials used to make adjacent “packaging” laminae that are positioned adjacent the major planar surfaces of the membrane.

A. Microwave Welding Generally

Microwaves are electromagnetic waves having a frequency between about 30 centimeters (a frequency of about 1 GHz) to about 1 millimeter (a frequency of about 300 GHz). Absorbed microwave energy is converted into heat. Materials in adjacent regions absorb the heat and can be brought to a temperature sufficient to allow bonding.

Microwaves in this frequency range have another interesting property: they are not absorbed by most plastics, glass or ceramics. As a result, microwave welding is used primarily where “microwave transparent” materials, such as polymers and ceramics, are used to make individual lamina that are then stacked and registered to define desired devices, or components of desired devices. Individual lamina can be bonded, even on the inside of a device, from a microwave energy source that applies energy from a position external to the device. This avoids having to (1) package the device in a housing, and/or (2) use a mechanical device, such as a clamp, to keep the laminae properly registered and assembled, thereby reducing size and weight, and allowing for device production intensification. The selection of materials used to construct the device is therefore determined, at least in part, by the technique used to bond the individual lamina, such as microwave welding for the present application, and the operational requirements. For example, where the device operates below or at room temperature to moderately higher temperatures, microwave transparent polymers can be used. Ceramic materials can be used for higher temperature applications.

B. Microwave Susceptible Materials

Microwave welding provides another advantage: heat produced as a result of electromagnetic energy absorption can be localized by appropriate placement of microwave susceptible material(s). Materials used to make membranes generally are more susceptible to heat damage than the substantially more rigid laminae used to define adjacent structures. One method for localizing heat production and to minimize heat damage to heat-labile materials is appropriate placement of a microwave susceptible material or materials.

In order to promote microwave welding, a microwave susceptible material may be positioned on or incorporated into one or more lamina that is to be welded to adjacent lamina or laminae. A microwave susceptible material is a material that absorbs microwaves, and converts the absorbed energy into heat energy, primarily as a result of molecular motion. A person of ordinary skill in the art will appreciate that there are a number of suitable microwave susceptible materials. Solely by way of example, and without limitation, microwave susceptible materials include metals, alloys and conductive polymeric materials. Specific examples of microwave susceptible materials include carbon, metals comprising iron, such as ferrite, conductive polymers, particularly organic polymers, copolymers, and conjugated polymers, such as poly(para-phenylene), poly(p-phenylenevinylene), polyaniline, and combinations thereof. The microwave susceptible material can be provided in any suitable form, including without limitation, powders, films, pastes, epoxies, and combinations thereof. Moreover, the microwave susceptible material may be dispersed in the material applied to the faying surface. The material in which the microwave susceptible material is dispersed can be substantially inert to heat production as a result of microwave absorption, or alternatively, such material may be an adhesive material that is cured upon absorption of the applied microwaves.

Microwave susceptible materials may be applied to lamina or laminae for bonding purposes by any suitable technique, ranging from the most simplistic comprising simple physical placement of the microwave susceptible material in desired regions; printing techniques, such as using an inkjet-printhead-based system to deposit liquids containing high dielectric nano-particles; deposition techniques, assuming that the materials used to make the desired device can withstand the application processes required to deposit the microwave susceptible material; coating techniques, such as dip coating; xerographic processes in which microwave-susceptible particles are selectively bound to faying surfaces using electrostatic forces; screen printing or printing through a stencil, particularly if the material is deposited in paste form; lithography-based methods; etc.

Selective deposition of microwave susceptible materials also can be combined with the patterning step, such as in the case of embossing or injection molding of laminae. As an example, a microwave susceptible material or powder comprising such a material could be put into energy director “slots” within the embossing mandrel or injection mold. As the embossing/molding occurs, the microwave susceptible material is transferred into or onto the features defining where the microwave susceptible material is to be positioned.

The amount of material applied to induce bonding typically is the minimum required to achieve desired bond strength and/or bond area at the faying surfaces. By minimizing the amount of microwave susceptible material used, the likelihood of contamination, either in the bond region or within the material used to form the laminae, by the microwave susceptible material also is concomitantly minimized.

It also is possible to enhance the application of microwave energy to the laminae stack by means other than using microwave susceptible materials or in combination with using microwave susceptible material. For example, the local temperature of the substrate may be selectively increased during microwave irradiation by using porous substrate materials or sub-wavelength structured (textured) surfaces which have different dielectric constants.

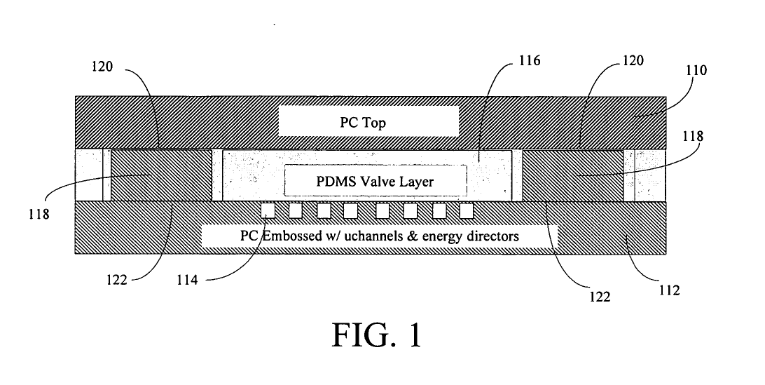

FIG. 1 is cross-section of a microfluidic device comprising plural laminae 10 and 12, such as might be made from a relatively rigid polymer like polycarbonate. Lamina 12 is patterned to include plural microchannels 14. A third lamina 16, made from an elastomeric material, such polydimethylsiloxane that is useful for defining, for example, a valve layer is positioned, i.e. registered, relative to laminae 10 and 12 and microchannels 14. Layer 16 may be a non-patterned lamina, or a patterned lamina, depending on the requirements of the particular device being constructed.

Laminae 10 and 12 can be welded together through the membrane layer 16 using microwave welding. The membrane layer 16 is constrained between the relatively stiff polymeric layers 10 and 12. FIG. 1 illustrates portions 18, referred to herein as standoffs, positioned adjacent the membrane polymer 16. These standoffs 18 can be made by patterning the lamina 12 to include such portions, such as by embossing, through cutting, molding techniques such as injection molding, etc. An efficient technique for making lamina 12 forms the standoffs 18, as well as the plural microchannels 14, in a single step. Alternatively, standoffs 18 can be formed separately from either lamina 10 and/or 12, and later positioned as shown in FIG. 1.

For a first situation where the standoffs 18 are formed from lamina 12, microwave susceptible material may be placed on at least a portion or substantially all of the major planar surface 20, i.e. the faying surface (the surface of a material in contact with another to which it is or will be joined) of standoffs 18. Furthermore, if required, microwave susceptible material also may be placed on a portion or substantially all of a faying region between the elastomeric layer 16 and lamina 10, lamina 12, or both. Lamina 10 is thereafter placed on top of and in contact with the standoffs 18 and the microwave susceptible material.

Alternatively, where standoffs 18 are formed separately from lamina 12 (and either from the same material used to form lamina 12, a different, substantially microwave transparent material, or combinations thereof), then microwave susceptible material can be applied, such as by dip coating, to at least a portion of or substantially all of both major planar surfaces 20 and 22.

The step of positioning the microwave susceptible material on the faying surface(s) of the lamina or laminae can be accomplished simultaneously with the patterning step that forms the features of the individual lamina. Solely by way of example, an embossing tool might be used to form features of the individual lamina while simultaneously applying the microwave susceptible material to the faying surface.

For certain devices, appropriate alignment of one lamina, such as lamina 10 or 12, relative to another, such as lamina 16 can be important for appropriate device operation. Standoffs 18 can be used to aid this alignment. For example, where the lamina 16 is an elastomeric layer, such layer may have apertures suitable for receiving standoffs 18 therein. Lamina 16 may be sized just slightly smaller so that, by placing the standoffs 18 through apertures in the lamina 14, lamina 14 is maintained in slight tension. This has several benefits. For example, this process allows lamina 16 to be first positioned correctly, and second to be maintained in a proper alignment, without surface irregularities, such as wrinkles or tears that may occur as the stacked laminae are manipulated during the device manufacturing process.

As stated above, microwaves occur over a range of frequencies. Best microwave welding results likely are obtained by matching the absorption capability of the microwave susceptible material to the applied microwave energy. The microwave spectrum of the microwave susceptible material can be used to determine over what frequency range the microwave susceptible material is absorbing or transmitting, and the applied microwave frequency can then be matched to the absorption range of the microwave susceptible material.

Stacked laminae are subjected to microwave welding to induce bonding. A bonding pressure also typically is applied to the stack for a period of time sufficient to obtain effective bonding. The strength of the weld at the faying surfaces, and the conformal seal formed, typically are proportional to the compression force applied during bonding. Thus, for a particular device, the requirements of the bond strength and the conformal seal, where present, can be used to determine the amount of pressure to be applied during the bonding process.

For example, where the conformal seal must be sufficient to preclude fluid leaks at fluid pressures of 50 psi, then the pressure applied during the microwave welding process should be sufficient to produce a conformal seal capable of withstanding the 50 psi requirement. Pressure is substantially proportional to surface area on which the bonding force is applied. If the surface area is substantially constant throughout a laminae stack, then the pressure applied to the outer surfaces of the stack can be considered, solely for purposes of guidance, to be substantially equal to or perhaps slightly greater than the requirements for the welded joint and/or conformal seal at locations adjacent microchannels and membranes. But, where there are microchannels and other features formed by the laminae stack, then the pressures may vary at those locations within the stack.

Many, but certainly not all, microfluidic devices operate at fluid pressures of less than one atmosphere (less than about 15 psi). Certain devices may operate at greater fluid pressures, such as within the range of from about 1 to about 10 atmospheres, more likely from about 1 to about 5 atmospheres, and even more typically from about 1 to about 2 atmospheres. As a result, the bonding pressure applied during the microwave welding process should be selected such that the device can withstand fluid pressures experienced during device operation. The pressure most desirably applied during the microwave welding process can be determined by empirical studies on model systems prior to implementing a commercial process, as will be understood by a person of ordinary skill in the art.

The pressures applied during the microwave welding process also are determined by the materials used to construct the device. The pressures must not be so high so as to result in failure of the material(s) used to construct the device. If, for example, the operational requirements are so high as to make microwave transparent material unsuitable for construction, then different materials will be required, and microwave welding will not be used to weld the laminae together to form the monolithic device. Solely by way of example, polycarbonate has a tensile strength of 58-70 MPa (8,500-10,000 psi). For polydimethylsiloxane the tensile strength at break is from about 3 to about 5 MPa.

Bonding pressure can be applied to the stack using fixtures. The fixture should be made from a material transparent to microwaves.

Bonding times for microwave bonding typically are significantly shorter than for other bonding techniques. As with bonding pressures, bonding times can be determined by the requirements of the device and the strength required in the bond areas and conformal seals, where present. The bond time period can vary, as will be understood by a person of ordinary skill in the art, and optimum energy application and bonding pressure times can be determined empirically for a particular architecture. For example, by controlling such variables as amount of microwave susceptible material, power of the microwave welding device, the time that the microwave energy is applied, the bonding pressure, etc. a person of ordinary skill in the art will thus be able to determine the parameters best used for a particular situation. However, solely for purposes of guidance, most welding times for polymeric materials will be short, on the order of seconds, whereas welding times for ceramic materials will be substantially greater, and may be on the order of minutes.

C. Continuous Process

The process of the present invention can be practiced both as a batch process and/or as a continuous process for commercial applications. For example, a continuous process may involve formation of laminae by continuous embossing processes, followed by stacking and registration of a first lamina adjacent at least a second lamina, such as by roll-to-roll feeding of materials and/or continuous conveyorized placement of lamina adjacent one another for subsequent continuous or batch microwave bonding. As with continuous heaters, a microwave welder can be provided whereby stacked and registered lamina to be bonded are moved through a microwave zone of sufficient length to allow application of microwave energy for a time sufficient to produce a suitable bond.

IR conveyorized ovens are known. Thus, it also is possible that the bonding process can involve application of an energy source, such as IR, to the laminae stack in addition to the microwave energy to facilitate and/or finalize the microwave bonding process.

A person of ordinary skill in the art also will appreciate that the process can be used to make a number of devices simultaneously by patterning a single lamina so that such individual lamina has the plural patterned zones, each zone of which is patterned appropriately for forming the desired device. Thus, when the lamina having the plural patterned zones is then stacked and registered with other lamina, each of which also includes plural patterned zones that are registered with the first lamina, plural devices are defined. These plural devices can then be cut from the stacked laminae to define individual devices that are then subsequently bonded. Alternatively the plural stacked lamina can be bonded, and then subsequently cut, such as by laser cutting, from the bonded stack to provide the individual devices.

The microwave process described herein provides several advantages relative to other processes for bonding a stack of laminae in a microlamination process, including: multiple laminae can be welded simultaneously; the process is quick, for example, a few seconds of microwave energy is enough to cause microwave susceptible material to fuse into silica; thermal energy can be isolated, thereby avoiding or minimizing damage to integrated membranes; relatively low bonding pressures yield better microlaminated geometries, which is important as high bonding pressures are known to cause permanent deformation, such as deformation of microchannels, within laminated structures.

### V. LASER WELDING

A. Generally

The basic principle of laser transmission welding, also known as transmission laser welding, hereinafter referred to as laser welding, is that two components are positioned to form a good lap joint. Laser energy is scanned through the surface to initiate bonding, provided one of the components, or a material placed on the component, is absorptive.

Certain useful materials, however, are transmissive to laser energy. For example, polycarbonate is transmissive (˜90%) to near-infrared (NIR). Conversely, STARMEM 122 Membrane, a commercially available polyimide membrane useful for separation processes, such as solvent resistant nanofiltration (SM122), is highly reflective in that spectral region. For these situations electromagnetic energy susceptible materials may be applied to transmissive materials to facilitate welding processes. For example, materials available from Gentex under the Clearweld® trademark(s)/service mark(s) promotes laser welding in laminae assemblies, particularly where none of the laminae strongly absorbs in the NIR. One Clearweld® material used strongly absorbed in the NIR region of from about 800 nanometers to about 1064 nanometers. Thin films of Clearweld® can be applied by various suitable methods, such as direct application with an applicator.

B. Bonding Heterogeneous Materials

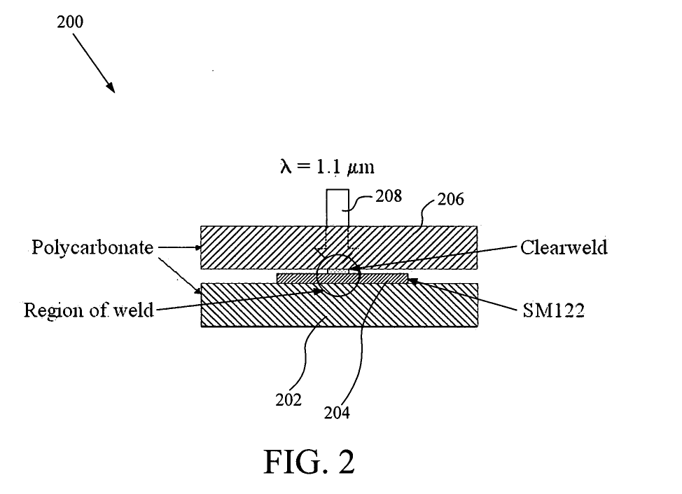

FIG. 2 schematically illustrates one embodiment of a laser welding process 200 comprising providing a first lamina 202 positioned adjacent a second lamina 204 made from a material having different physical properties than the material of lamina 202. For working embodiments, polycarbonate was a common material used for lamina 202, and a membrane material, such as SM122, was a common material used for lamina 204. Third lamina 206 may be made from the same material as lamina 202 or a different material, but for working embodiments lamina 206 also was polycarbonate. During the welding process, laser light 208 at a selected wavelength, which in the illustrated embodiment was 1.1 μm, passes through a polycarbonate lamina and is absorbed by a thin film of Clearweld® causing a localized increase in temperature. Processing variables, such as temperature, clamping force and miscibility of the respective polymers, can be adjusted to cause the melted laminae to fuse and upon cooling form a weld.

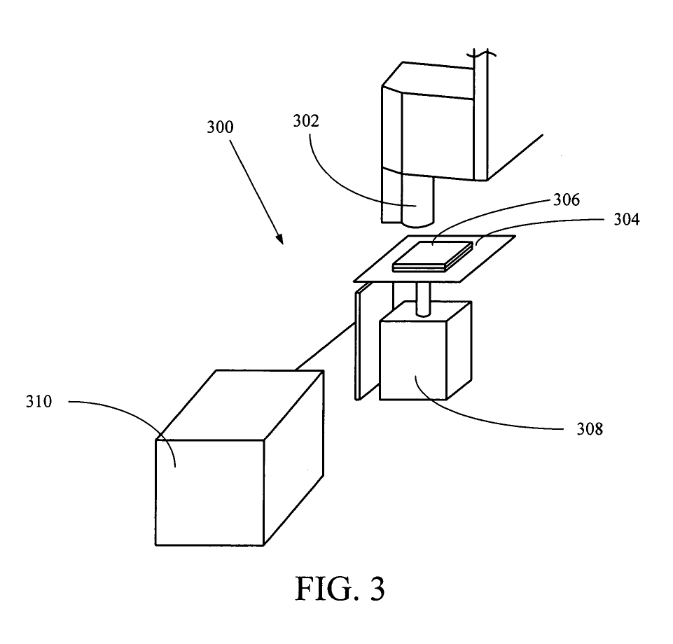

FIG. 3 illustrates a system 300 for motion control during laser welding devices as disclosed herein comprising a laser terminus 302 positioned effectively adjacent a platform 304 to which an assembly 306 is coupled. System 300 includes a stepper motor 308 coupled to platform 304 for moving the platform in the θ-axis. One embodiment of stepper motor 308 included a stepper motor, controller circuit board, DC power supply, and a LabVIEW 7.1VI to control the frequency of steps and relative position of rotation of the platform about the θ-axis. Motor 310 is effectively coupled to the platform for additional movement, such as movement in the x axis. One embodiment of motor 310 was a SmartMotor system (Animatics) having a brushless DC servo motor, motion controller, encoder, amplifier and an RS-232 computer interface to control the acceleration, velocity and absolute position of the platform along the x-axis.

The SmartMotor is programmed so that the computer can communicate to the motor. The following motor instructions were executable by typing commands using the following code: A=100 ‘Set Acceleration in rev/sec*sec; V=100000, ‘Set Velocity in rev/sec.; P=2000, ‘Set position in revolutions; G, ‘Start motion. The position and velocity of an assembly could be changed using the motor.

A cylindrical magnet (not shown) provided clamping force on the assembly normal to the top surface of platform surface. Two other small magnets defined registration surfaces on the edge of the platform. The screw holding the platform onto the stepper motor defined the origin for both the x-axis and θ-axis.

The stage was positioned either by hand (with the SmartMotor “OFF”) or by positioning with the SmartMotor interface such that the laser spot is directly incident upon the center of the screw holding the platform to the stepper motor. The origin was reset to zero so that any position of the x-axis by the SmartMotor defined the radius of a circle described by the rotation of the platform by the stepper motor.

C. Laser Welds

Features of the laser welding embodiment that may contribute to the strength of a weld formed include: laser power density (I); film width (w), of any bonding agent added to facilitate the process, such as Clearweld®; density (p) of any bonding agent added to facilitate the process, such as Clearweld®; and substrate velocity (v) relative to the fixed laser beam. Without being limited to a theory of operation or function, each of these appears to affect the doseage (D) delivered to the assembly as indicated below by Equation 1.

$$D ∝ \frac{P \cdot w \cdot ρ}{h \cdot v} \qquad ( 1 )$$

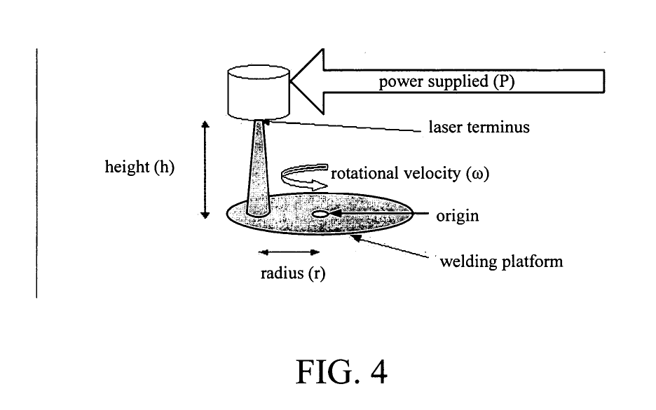

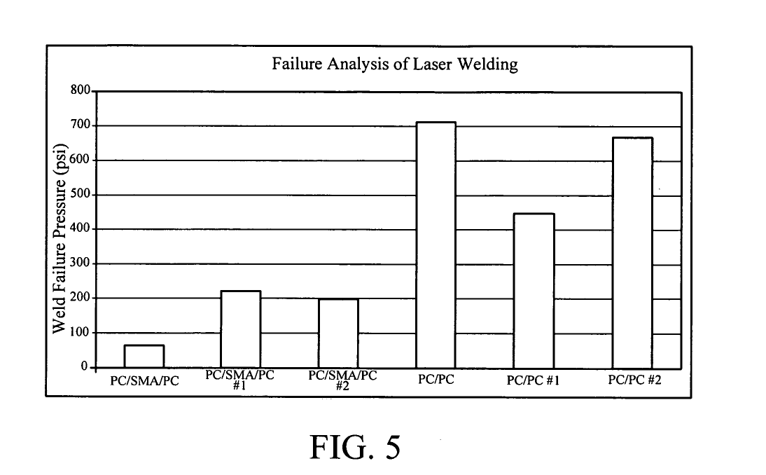

Two parameters control the laser power density (FIG. 4). The first parameter was the power setting (P) provided by the laser power supply. The maximum power supplied by a power supply in a working embodiment was 12 W. In the results presented here, the power supplied for welding was held constant at 10 W. The second parameter that controlled the laser power density was the relative height (h) of the laser terminus above the welding surface. Since the beam diverged from the terminus, the closer the terminus was to the platform the smaller the spot size and, subsequently, the greater the power density. In the results presented here, the height was held constant at 10 cm.

With continued reference to FIG. 4, the substrate velocity of the welding surface relative to the beam was controlled by two factors: the radius of the weld (r) and the rotation velocity of the platform (ω). The radius of the weld was defined by the x-axis translation away from the origin. The rotational velocity of the platform was determined by the frequency of rotation of the stepper motor. With an increase in radius, the rotational velocity must be decreased to maintain a constant linear velocity according to Equation 2.
v=rω (2)
The Clearweld® thin film width and density were both influenced by the quality of the line applied to the lamina with the Clearweld® marker. The strongest welds were achieved with the greatest amount of Clearweld® applied.

Additional detail concerning methods for forming welds with plastic materials is provided by U.S. Pat. Nos. 6,656,315 and 6,911,262, assigned to Gentex Corporation. The '315 patent describes selection criteria for laser welding dyes that predicts efficiency and performance for plastics welding.

Additional detail concerning one working embodiment of a method for welding polycarbonate laminae with an interspersed membrane layer is provided in the examples.

### VI. EXAMPLES

The following working examples disclose certain features of the invention intended to exemplify aspects of the present invention. The scope of the invention is not limited to these particular features.

### Example 1

A. Separation Assembly

This example concerns one embodiment of a method for forming a prototype separation assembly using laser welding. The materials used to form the assembly were polycarbonate, SM122 membrane, tape, and Clear-Weld Pen. The equipment used included shear, F500-24 DC IN 24V 0.45 A Cosel Laser, FJW Find R Infrared Scope 1.2 micron, laser welding platform, linear actuator for x-axis platform control, stepper motor for θ-axis platform control, round NbFeB Magnet (18 mm), and small round NbFeB magnets (8 mm).

The following welding parameters were used: z=5 cm (distance from laser fiber terminus to polycarbonate surface); P=10 W (power setting for laser); f=10 Hz (step frequency of stepper motor); r=56,200 (number of SmartMotor steps to define 1.784 cm radius).

The following steps were used to prepare polycarbonate laminae. Two polycarbonate pieces 7.5 cm×7.5 cm were cut with the shear. Two adjacent edges of each piece were positioned perpendicularly, so that such edges serve as registration surfaces during the assembly. A small amount of the corner formed by the perpendicular edges was sheared to mark the location of the registration edges. A 3/32” hole was drilled in the center of one piece to mount a pressure connection.

A 5 cm×5 cm piece of SM122 membrane was cut and the backing removed. Protective film from both sides of the non-drilled polycarbonate were removed and positioned on the laser welding platform. Two small round magnets were positioned on two adjacent sides of the laser welding platform with their faces coincident with the edge of the platform. The edges of the polycarbonate were registered using the faces of the magnets. The SM122 membrane was centered on top of the polycarbonate with the yellow side facing upward. The membrane was secured in position with a small amount of adhesive tape at two opposite corners.

The following steps were used to apply Clearweld®. A round magnet centered on top of the SM122 membrane. The linear actuator was set to P=56,200, the stepper motor was set at f=1000 Hz, and the laser turned on at 0 W. An infrared scope was used to ensure that the laser in following the correct path without contacting the round magnet. While looking through the infrared scope, the Clearweld® pen was used to draw a circle in the laser beam path. The tip of the pen was aligned with the laser beam.

Laser welding was performed as follows. A second lamina of polycarbonate was placed on top of the membrane aligning the two clipped corners, and a magnet was placed on top of the polycarbonate. The stepper motor and laser were started at the previous settings. The infrared scope was used ensure that the laser in following the correct path without contacting the round magnet. The laser welding platform was then used to make slightly more than a full rotation with an overlap of the weld of approximately 5 mm. Scraps of the membrane were removed and tape from the un-welded polycarbonate. The welded polycarbonate was placed on the laser welding platform with the white side of the polycarbonate up. Clearweld® was applied, and a second laser weld was formed by applying actuating the laser.

B. Pressure Testing

Assemblies welded as disclosed in this example were tested under pressure at ambient conditions. Pressure was supplied from a nitrogen (N₂) cylinder via 1/16” OD PEEK tubing and Nanoport fittings designed to accept the tubing (Upchurch Scientific). The test assemblies were immersed in a shallow water bath so that leaks could be detected as bubbles. No clamping force was provided to restrict the expansion of the welded assemblies.

The applied pressure was increased at 1 psig intervals from 0 to 30 psig and at 5 psig intervals from 30 psig to failure. The pressure was increased every 30 seconds to ensure the system had reached the target pressure before moving on.

The polycarbonate/polycarbonate welds tended to fail by shearing through one of the polycarbonate laminae at the weld line whereas the polycarbonate/SM122/polycarbonate welds tended to fail by crack propagation through the weld. The polycarbonate/polycarbonate welded assemblies expanded markedly out-of-plane at 30-40 psi and remained in that conformation until failure. However, the polycarbonate/SM122/polycarbonate welded assemblies did not show that same expansion even at pressures greater than 40 psi.

C. Pressure Test Results

Two sets of pressure tests were conducted. The first found the average failure pressure of the weld between the SM 122 membrane and two polycarbonate laminae (polycarbonate/SM122/polycarbonate) to be 160 psi. The second found the average failure pressure of the weld between two polycarbonate laminae (polycarbonate/polycarbonate) to be 610 psi.

TABLE 1
Failure analysis of polycarbonate and STARMEM122 welds

| | Pₘₑₘ | Aₘₑₘ | Aₘₑₘ | Fₘₑₘ | C_{weld} | w_{weld} | A_{weld} | A_{weld} | P_{weld} |
|---|---|---|---|---|---|---|---|---|---|
| Material | (psig) | (cm²) | (in²) | (lbs) | (cm) | (cm) | (cm²) | (in²) | (psi) |
| polycarbonate/SMA/ | 7 | 10 | 1.6 | 11 | 11.2 | 0.1 | 1.1 | 0.17 | 62 |
| polycarbonate | | | | | | | | | |
| polycarbonate/SMA/ | 50 | 10 | 1.6 | 78 | 11.2 | 0.2 | 2.2 | 0.35 | 223 |
| polycarbonate #1 | | | | | | | | | |
| polycarbonate/SMA/ | 45 | 10 | 1.6 | 70 | 11.2 | 0.2 | 2.2 | 0.35 | 201 |
| polycarbonate #2 | | | | | | | | | |
| polycarbonate/polycar- | 80 | 10 | 1.6 | 124 | 11.2 | 0.1 | 1.1 | 0.17 | 714 |
| bonate | | | | | | | | | |
| polycarbonate/polycar- | 50 | 10 | 1.6 | 78 | 11.2 | 0.1 | 1.1 | 0.17 | 446 |
| bonate #1 | | | | | | | | | |
| polycarbonate/polycar- | 75 | 10 | 1.6 | 116 | 11.2 | 0.1 | 1.1 | 0.17 | 669 |
| bonate #2 | | | | | | | | | |

| | |
|---|---|
| | (3) |
| ${P}_{weld} = \frac{{F}_{mem}}{{A}_{weld}} = \frac{{P}_{mem} \cdot {A}_{mem}}{{C}_{weld} \cdot {w}_{weld}}$ | |

### Example 2

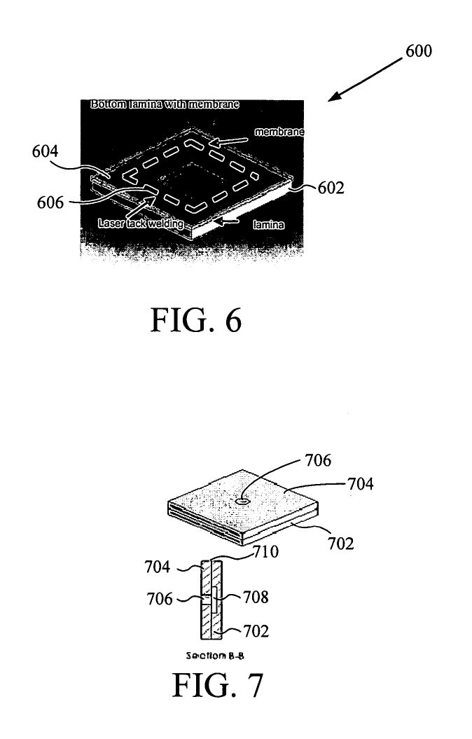

This example concerns a work piece made using laser welding. The components used for this example are illustrated schematically in FIGS. 6-7. With reference to FIG. 6, the work piece comprised a first polycarbonate lamina 602 (750 microns). A membrane lamina 604 was placed on lamina 602. Two different types of membranes were used, a regenerated cellulose acetate membrane having a polypropylene backing (250 microns) and an AN69 membrane (20 microns) from GmgH Gambro.

A Branson IRAM100 laser welder was used having a 50-400 pound force pneumatic lift on a servo-driven X-Y stage and computer controllable scan speed (see Appendix a). The laser is held rigid (adjustable) at the required focal distance. Generally, it is best to use the minimum bonding pressure that will provide a suitably strong weld for the end application. For this example, 1 inch by 1 inch test coupons were used, and the applied bonding pressure was between about 50 to about 60 psi.

With reference to FIG. 6, work piece 600 had a first polycarbonate lamina 602 and a membrane lamina 604. Work piece 600 was placed in a sample holder. Clearweld® was manually applied using a Clearweld® marker on areas 606 as indicated in FIG. 6 to form laser tack welding positions according to one embodiment of the present invention.

FIG. 7 illustrates an assembly 700 both perspectively and in cross section. Assembly 700 had a bottom lamina, a top lamina 704 having a through aperture 706. In cross section, aperture 706 feeds to channel 708 through membrane 710.

The work piece was lifted against a quartz plate for application of pressure during laser scan. The welded samples were tested for bond strength through peeling and vacuum pulling test. Bonding between PC-PC laminae was quite strong and sustained more than 25 psi of pressure. The PC-membrane welding was not so strong.

### Example 3

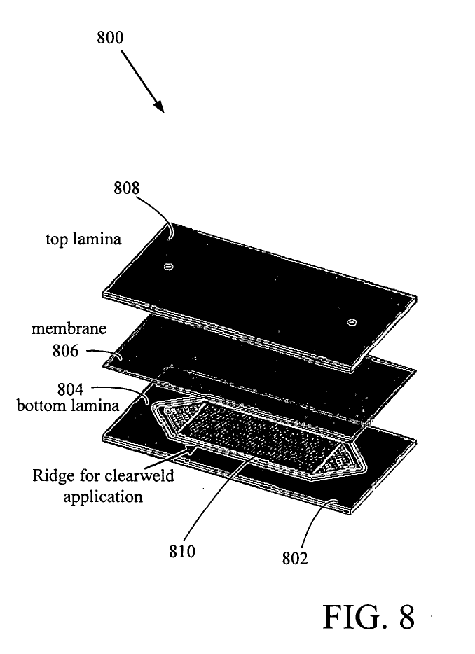

Test coupons (1 inch×3 inches), such as test coupons made from an assembly 800 in FIG. 8, were designed in SolidWorks for pressure testing and bond strength measurement. Assembly 800 comprises a bottom patterned lamina 802 having a raised ridge of clear weld 804. Membrane 806 was positioned between bottom lamina 802 and a top lamina 808. A ridge of 50 μm high and 500 μm wide for AN69 and 200 μm high and 500 μm wide for cellulose acetate membrane, to which Clearweld was applied, was provided around the patterned features 810 as a crushing height to encapsulate membrane 806 between laminae 804, 808. The AN69 membrane was stretched to keep it flat and wrinkle-free between the laminae during welding. Uniform application of pressure provides intimate contact between two surfaces to be welded, to transfer heat from one substrate to the other, and to prevent separation of the substrates during the cooling phase. The device with AN69 membrane was welded in one step.

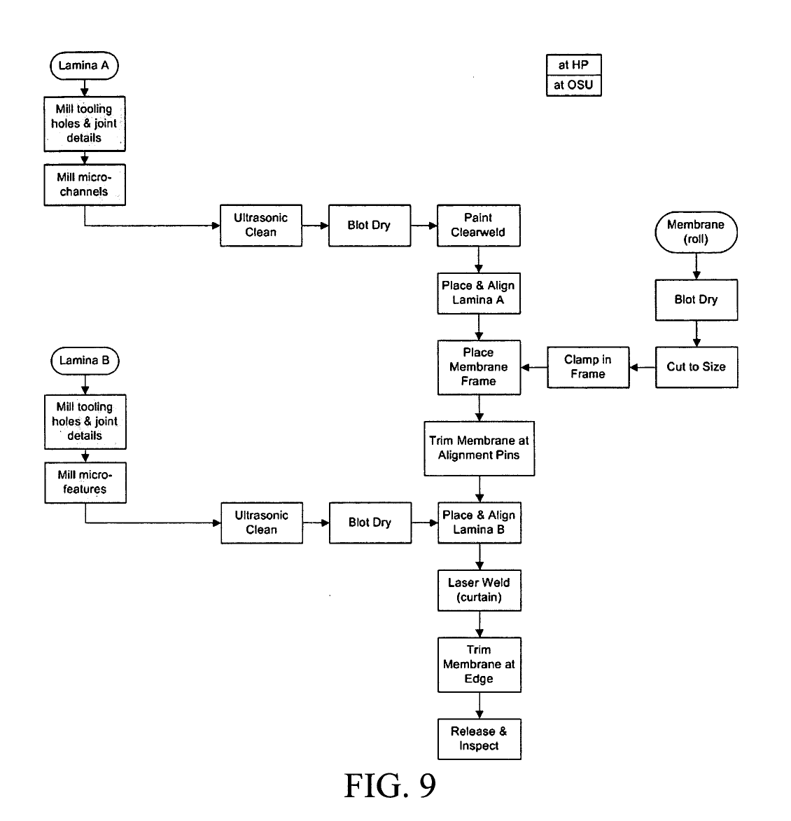

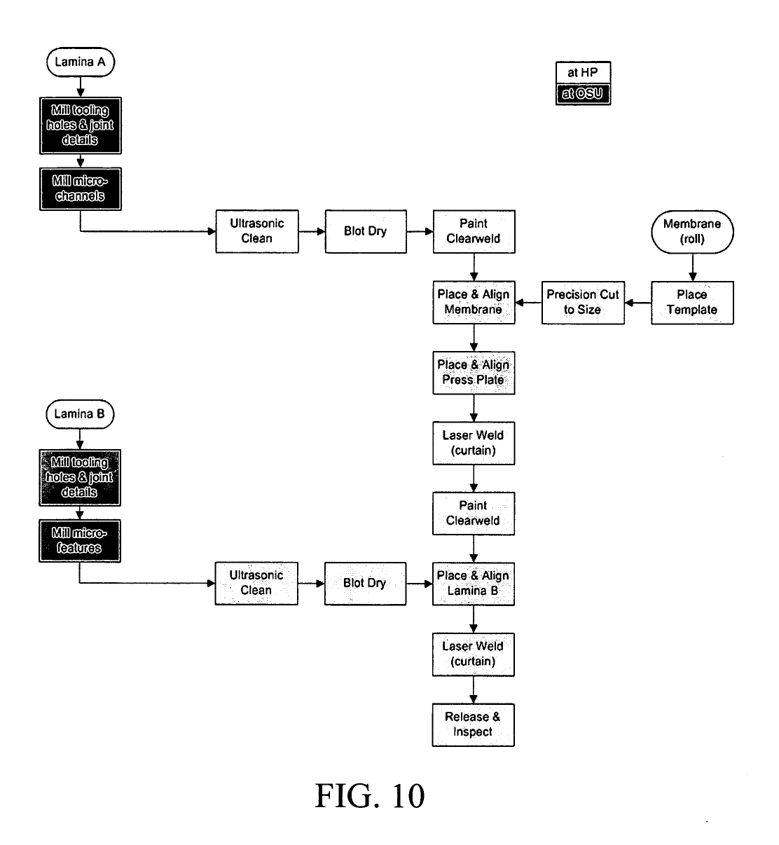

For cellulose acetate membranes the process was divided into two steps due to the increased thickness of membrane 806. First the membrane 806 was welded along the ridges of bottom lamina 804. A quartz plate having the same size of the underlying portion of the assembly 800 was placed on the membrane 806 to transfer pressure. The second step welded the top lamina with the bottom lamina to secure the membrane inside. A flow chart for the process of this example is provided by FIG. 9.

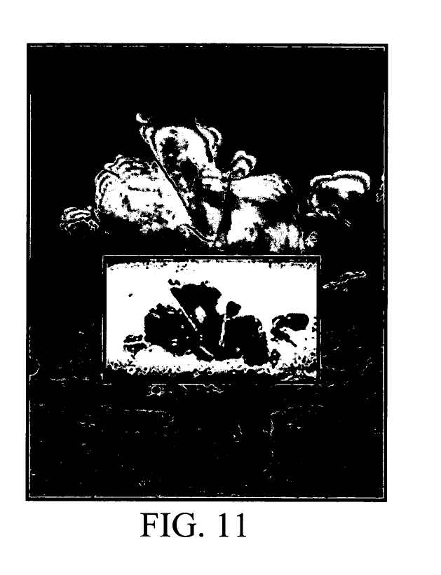

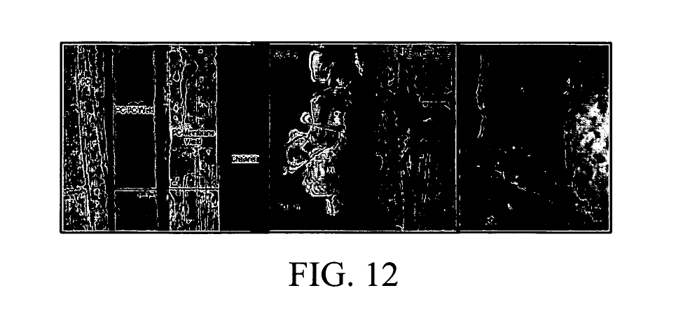

Welds were visually inspected and images were collected with two different microscopes. A Zeiss Axiotron Upright Microscope equipped with a Sony PowerHAD digital camera and Image Pro® Plus analysis software was used for brightfield images and bonded area calculations. A Zeiss Laser Scanning Microscope 510 (LSM) was used for higher quality inspection and 3D visualization. Both systems were calibrated to perform micrometer scale measurements with the appropriate manufacturer supplied standards. The transparency of the polycarbonate substrate and post-weld Clearweld® allowed 3D images to be compiled via LSM by stacking a series of images taken in successive Z-planes. The fraction of bonded areas was calculated with the Image Pro® software by isolating the area of interest in the picture. All pixels containing a similar hue and saturation characteristic of the bonded area were then chosen and used to apply a mask to easily discriminate the bonded area. See, FIG. 11. The relative number of bonded-to-total pixels was used to calculate the percent area bonded. The bonded area of the PC-PC weld was calculated by taking 22 samples around the weld seam. To determine the bonded area of the PC-membrane weld (same device), 10 samples were used as this weld is less critical to bond failure.

Channels were measured to be approximately 260 μm wide and 120 μm high. The width of the PC-PC weld was found to be approximately 600 μm while that of the membrane-PC weld was ˜700 μm thick for both the membranes. FIG. 12 demonstrates that weld quality varies significantly for a given weld seam and displays an area of weld failure. It is apparent from FIG. 11 that the Clearweld® area is not bonded equally throughout the weld seam. The average bonded area was found to be 86%±21%. This high standard deviation is indicative of the variability around the weld seam. Greater than half of the samples were considered 100% bonded and greater than 92% of the samples have higher than 50% bonding. The PC-membrane weld had an average bonded area of 48%±12%. Clearweld® application and subsequent laser welding may result in significant damage to the membrane. Additionally, uncontrolled application of the Clearweld® solution can result shape variation of the final device by filling the channels. It is implied that filling of the channels with Clearweld® can also damage the membrane and further reduce device efficiency.

Tests were conducted to determine at what pressure do laser welded PC test coupons begin to leak. A secondary experiment using a device known as a “Nanoport” was conducted to determine the ultimate burst pressure of a device consisting of two laser welded polycarbonate layers.

The primary apparatus for conducting these tests was a Flow Loop Station. A Flow Loop Station is a device primarily used to test pressure drop across High Aspect Ratio Micro-Channel Array Devices (HARM Array Devices). Here it was used to measure the amount of fluid pressure (Air) being applied to the test coupon. The apparatus for the Flow Loop test include a main (aluminum) manifold, a rubber gasket, a transparent polycarbonate backing plate, and two bar clamps using two 7/16″ Hex bolts each for clamping force. The aluminum manifold supplies air to the test coupon via a hose connected to the flow loop station. The rubber gasket provides a seal between the aluminum manifold and the polycarbonate test coupon. A polycarbonate backing plate was used to keep the test coupon from bulging, and two aluminum bar clamps were used to provide mechanical clamping force to the fixture. The test coupon was placed with its corners closest to the bar clamps to prevent any direct clamping over a welded area. This entire assembly was then placed under water in a glass container for the duration of the test procedure i.e. about 5-10 minutes.

The entire fixture assembly (with a test coupon in place) was submerged in water and air is purged into the coupon. Leaks were identified by air bubbles emitted from the sides of the test coupon. Tests were conducted at two pressures (10 psig and 15 psig) with two sample types (PC-PC welded and PC-membrane-PC welded). The most significant difference between these tests with respect to testing weld strength is that the flow loop tests the sidewall strength of the weld whereas the Nanoport Burst experiment tests the raw strength of the entire test coupon. In the former, the primary failure mechanism is the normal force applied to the weld. In the latter, there is also a shear force applied as the polycarbonate plates deflect with increased pressure.

The results of flow loop pressure test are provided in Table 2. After testing six test coupons, not a single one leaked at either the 10 psig or 15 psig levels.

TABLE 2
Flow Loop Experiment Results

Pressure (psi)

| Sample | Sample # | 10 psig | 15 psig |
|---|---|---|---|
| PP | 1 | PASS | PASS |
| PP | 2 | PASS | PASS |
| PP | 3 | N/A | N/A |
| PP | 4 | N/A | N/A |
| PCP | 1 | PASS | PASS |
| PCP | 2 | PASS | PASS |
| PCP | 3 | PASS | PASS |
| PCP | 4 | PASS | PASS |

The Nanoport burst test uses a device known as a “Nanoport” as a manifold for directing fluid (N₂ gas) into the test coupon. The Nanoport is secured to the test coupon via an adhesive tape and is threaded on to a male nozzle at the end of a hose. Fluid flow through the hose is achieved via a pressurized bottle of N₂ gas and a regulator with a pressure gage and an adjustable valve. Manipulating the valve changes the pressure inside the hose. The test coupon and Nanoport assembly were submerged in water and observed while increasing the amount of pressure pumped into the sample. Specific procedures included cleaning the test coupon/Nanoport mating surfaces with methanol; applying the adhesive tape to the Nanoport and placing the Nanoport over the inlet hole of the test sample; clamping the test coupon/Nanoport assembly between a large paper clamp and placing the assembly in an oven at 95° C. oven for approximately 1.5 hours; removing test coupon/Nanoport assembly from the oven and allowing to cool to room temperature; removing the paper clamp; threading the Nanoport on to the male nozzle and submerging the assembly in water; opening controlling fluid flow from the nitrogen bottle to the test sample and begin ramping pressure at a rate of 2.5 psig per minute (holding each 2.5 psig interval for no less than 30 seconds) until the sample bursts.

Nanoport burst test results are provided by Table 3.

TABLE 3
Nanoport Burst Experiment Results

| Sample | Sample # | Burst Pressure | |
|---|---|---|---|
| PP | 3 | 0 | psig¹ |
| PP | 4 | 16 | psig |

In view of the many possible embodiments to which the principles of the disclosed invention may be applied, it should be recognized that the illustrated embodiments are only preferred examples of the invention and should not be taken as limiting the scope of the invention.

We claim:

1. A welding process, comprising:
providing plural heterogeneous laminae that assembled define at least a portion of a fluidic device; and
applying electromagnetic energy to the materials for a period of time sufficient to effectively bond the heterogeneous materials together.

2. The welding process according to claim 1, further comprising:
providing plural laminae that collectively define at least a portion of a microfluidic device, the plural lamina comprising laminae of a first material positioned adjacent at least one lamina of a second material; and
applying electromagnetic energy to the plural laminae for a period of time sufficient to bond the plural laminae together.

3. The welding process according to claim 2 comprising applying an electromagnetic energy susceptible material on at least a portion of a faying surface of one or more of the plural lamina to absorb applied energy.

4. The process according to claim 3 where the electromagnetic energy susceptible material is a metal, a metal alloy, a conductive polymer, or combinations thereof.

5. The process according to claim 3 where the electromagnetic energy susceptible material is carbon, a metal material comprising iron, a conductive polymer selected from polypara-phenylene), poly(p-phenylenevinylene), polyaniline, and combinations thereof.

6. The process according to claim 4 where the electromagnetic energy susceptible material is provided as a powder, film, paste, epoxy, or combinations thereof.

7. The process according to claim 2 where at least a portion of the lamina include a microwave susceptible material.

8. The process according to claim 3 where the electromagnetic energy susceptible material is placed on at least a portion of the faying surface of the laminae by a method selected from the group consisting of dip coating, inkjet-based systems, xerographic processes that deposit microwave susceptible particles using electrostatic forces, screen printing, stencil printing, lithography-based methods, and combinations thereof.

9. The process according to claim 2 where the first material is a substantially rigid polymeric or ceramic material.

10. The process according to claim 9 where the second material is a membrane.

11. The process according to claim 9 where the first material is polycarbonate.

12. The process according to claim 9 where the second material is polysulfone, nanocrystalline cellulose, and combinations thereof.

13. The process according to claim 3 where the electromagnetic energy is microwave energy and microwave susceptible material is dispersed in a material curable by heat production as a result of microwave absorption by the microwave susceptible material.

14. The process according to claim 2 where at least a portion of the plural laminae are patterned laminae.

15. The process according to claim 14 where laminae are patterned simultaneously with the application of electromagnetic energy susceptible material susceptible material to faying surface(s) of the laminae.

16. The process according to claim 2 where a first material is substantially rigid, a second material is less rigid and includes apertures for receiving portions defined by the first material therein, such portions acting to register the second material and to maintain tension on the second material.

17. A continuous process according to claim 1.

18. The process according to claim 3 further comprising determining the electromagnetic energy absorption frequency range of the electromagnetic energy susceptible material, and selecting an applied electromagnetic energy susceptible material frequency within the absorption frequency range of the electromagnetic energy susceptible material.

19. The process according to claim 2 further comprising subjecting the plural laminae to first and second energy sources.

20. The process according to claim 19 where the first and second energy sources are laser and microwave.

21. The process according to claim 19 where one of the first and second energy sources is IR.

22. The process according to claim 19 where one of the first and second energy sources is heat energy.

23. The process according to claim 2 further comprising subjecting the plural laminae to at least a second bonding process selected from the group consisting of diffusion soldering/bonding, thermal brazing, adhesive bonding, thermal adhesive bonding, curative adhesive bonding, electrostatic bonding, resistance welding, microprojection welding, ultrasonic welding, and combinations thereof.

24. The process according to claim 2 where the laminae comprise a porous substrate material to selectively enhance temperature.

25. The process according to claim 2 where a faying surface comprises a sub-wavelength structured surface having different dielectric constants to selectively enhance temperature during microwave bonding.

26. The method according to claim 2 wherein at least one lamina of the first material includes standoffs, the method further comprising positioning microwave susceptible material on a faying surface of the standoffs to direct microwave energy absorption.

27. The method according to claim 2 where an assembled device made according to the process is a gas separator, a microchannel fuel processing system, a heat pump, a water purifier, a dialyzer, a biodiesel reactors, or a microreactor for molecular manufacturing.

28. The method according to claim 2 further comprising applying a bonding pressure to the plural laminae.

29. The method according to claim 30 comprising applying a bonding pressure simultaneously while applying electromagnetic energy.

30. The method according to claim 28 where the bonding pressure is selected to provide a weld joint strength and/or conformal seal sufficient to withstand fluid pressures experienced during device operation of up to 10 atmospheres.

31. A device made according to the method of claim 2.
